(19) United States
(12) Patent Application Publication
(10) Pub. No.: US 2013/0114375 A1
(43) Pub. Date: May 9, 2013

(54) Seismic Acquisition Method for Mode Separation

(71) Applicants: Mark A. Meier, Houston, TX (US); Christine E. Krohn, Houston, TX (US); Marvin L. Johnson, Chromo, CO (US); Michael W. Norris, Cypress, TX (US); Mat Walsh, Houston, TX (US); Graham A. Winbow, Mill Creek, WA (US)

(72) Inventors: Mark A. Meier, Houston, TX (US); Christine E. Krohn, Houston, TX (US); Marvin L. Johnson, Chromo, CO (US); Michael W. Norris, Cypress, TX (US); Mat Walsh, Houston, TX (US); Graham A. Winbow, Mill Creek, WA (US)

(21) Appl. No.: 13/810,412

(22) PCT Filed: May 23, 2011
(86) PCT No.: PCT/US11/37589

§ 371 Date: Jan. 15, 2013

Related U.S. Application Data
(60) Provisional application No. 61/367,734, filed on Jul. 26, 2010.

(51) Int. Cl. G01V 1/38; G01V 1/40

(52) U.S. Cl. CPC G01V 1/3808; G01V 1/40
USPC 367/21; 367/31

(57) ABSTRACT

Method for separating different seismic energy modes in the acquisition (65) of seismic survey data by using sensors that preferentially record a single mode (63), optionally combined with a source that preferentially transmits that mode.

### CROSS-REFERENCE TO RELATED APPLICATION

This application claims the benefit of U.S. Provisional Patent Application 61/367,734, filed Jul. 26, 2010, entitled SEISMIC ACQUISITION METHOD FOR MODE SEPARATION, the entirety of which is incorporated by reference herein.

### FIELD OF THE INVENTION

This invention relates generally to the field of seismic prospecting in land, ocean bottom, and borehole settings, and more particularly to methods of acquisition of seismic data. Specifically, the invention is a seismic acquisition method that separates or distinguishes various seismic energy modes by use of sensors that respond selectively to a desired mode of wave propagation, or have mode dependent responses. The method may also use sources capable of initiating a single mode or groups of modes whose energy distributions can be made to differ in a desirable way. The acquired data may be used to determine structure and physical properties of the subsurface.

### BACKGROUND OF THE INVENTION

Wavefields created from seismic energy sources are known to be complex. This is true for natural seismic sources (e.g., earthquakes), as well as artificial seismic sources, including those used in commercial seismic exploration. Seismic wavefields are complex because the earth hosts many modes of wave propagation. Furthermore, the inhomogeneous, anisotropic, and other complex characteristics of the earth complicate the behavior of any single mode, and induce mode conversions. Each mode has distinguishing physical characteristics and can provide particular information about the earth. Two classifications of modes commonly referenced are body waves, which are waves that propagate through the body of a medium, and interface waves, which are waves that propagate along a boundary. Examples of body waves are P-waves (also called compressional or longitudinal waves) and S-waves (also called shear or transverse waves). P-waves and S-waves are two different modes. Examples of interface waves (also called surface waves or ground roll when the interface is the earth's surface) include Rayleigh waves, Love waves, and Scholte waves. Boreholes may also host types of interface waves often referred to as tube waves or Stoneley waves. In this document, modes of wave propagation in the earth are referred to as “seismic energy modes”, “energy modes”, or simply “modes”. “Mode separation” is a process of distinguishing one mode, or a group of modes, from another mode or other modes.

Seismic exploration as practiced for the purpose of hydrocarbon exploration is primarily interested in backscattered body waves from the earth's subsurface (e.g., from seismic reflectors). Backscattered body waves are often described in terms of the modes of wave propagation between the source, backscatter (or reflector) location, and sensor. For example, a longitudinal wave that travels from a source to a reflector and from the reflector to a sensor is called a PP-wave. A reflected shear wave may also be generated from the same incident longitudinal wave. That wave is called a PS-wave. A shear wave that travels from a source to a reflector, then to a sensor, is called an SS-wave. Though many modes are typically recorded in seismic acquisition, it is usually only a single backscattered body wave that is desired. The desired backscattered body wave is then used to obtain information about the subsurface structure, impedance, reservoir fluids, etc., of the earth.

Commercial seismic practice can be described in two parts; the first part is seismic data acquisition or simply, “seismic acquisition.” The second part is seismic data processing, or simply “seismic processing.” Seismic acquisition involves the activities of measuring the earth's seismic response. It uses sources (or shots) to excite seismic waves in the earth, and sensors (or receivers) to measure the seismic waves excited by the source. The result of seismic acquisition is a seismic data set composed of recordings of measurements from sensors at a multitude of locations. The recordings are made, respectively, for a source or sources at each of a multitude of locations. Seismic processing uses the seismic data set to ascertain information about the subsurface such as structure, impedance, etc. It includes processes such as imaging and inversion.

Conventional seismic acquisition is based on recording either the omni-directional pressure field (e.g., hydrophones) and/or translational motion (e.g., geophones or accelerometers). Hydrophones are deployed in fluid media, which are capable of hosting only compressional waves. In this case, only compressional waves encounter the hydrophone, so in this situation the hydrophone is not being used to separate modes. Geophones and accelerometers are often deployed on the earth's surface, which is capable of hosting many modes. Because translational motion is a characteristic of all modes, a localized measurement of translational motion at a single station does not distinguish modes. A further complication is that conventional seismic sources (impulsive and vibrational) generate multiple modes. The energy partitioning into particular modes is uncontrolled, often with more energy in undesired modes and less energy in desired modes. The result is an acquired data set populated with many modes.

Conventional seismic processing typically includes several tasks. One of the primary tasks is to isolate a desired mode, such as a backscatter body wave, from the many other modes recorded in seismic acquisition. This process can be referred to as mode separation, though is often referred to as one of several steps of noise attenuation. Typically, the desired backscatter body wave is the PP-wave, but may also be other backscatter body waves such as PS- or SS-waves. If the desired mode has dominant amplitude over other modes, then mode separation processing may not be necessary. The smaller amplitude modes may be left in the data as acceptable error or noise present with the desired mode. If other modes have comparable or greater amplitudes to the desired mode, then mode separation processing may be needed. A common practice in seismic processing is to isolate the desired mode by attenuating, filtering, or otherwise rejecting undesired modes in the seismic data. For this strategy to be successful, the undesired mode must be separable from the desired mode in some manner. For example, if the desired mode and undesired mode(s) occupy different frequency bands, then pass-band filtering can separate the modes. The modes may also be separable by their travel time between source and sensor, apparent velocity, spatial frequency, or other characteristics or combinations of characteristics in one or more spatial domains (common shot, common receiver, common midpoint, common offset, common azimuth, etc.).

Seismic processing techniques to separate modes are not always effective. Many reasons can exist, but generally reduce to the problem that conditions required to completely isolate modes from one another are rarely satisfied. For example, the PP-wave occupies a much broader range of apparent velocities and spatial frequencies if the earth structure is complex rather than plane layered. A mode that is not well isolated in some manner cannot be separated by processing. The compromise is to accept some loss of information either by rejecting or attenuating parts of the desired mode along with the undesired mode(s), or accepting parts of undesired mode(s) as noise or error present with the desired mode.

One example of a problem of mode separation in seismic processing is illustrated by interface waves at the earth's surface (surface waves or ground roll). Ground roll is commonly encountered in commercial land seismic surveys. It's amplitude is typically dominant over other modes. To fully attenuate ground roll, spatial sampling of the wavefield must be sufficient to avoid aliasing within the frequency band of the desired mode. Land seismic surveys traditionally collect seismic data using sensor stations separated by a uniform spatial interval. For 3D seismic surveys, the inline spatial interval is normally smaller than the crossline spatial interval. Typical inline sensor station intervals are 6.25 to 300 meters. Typical crossline sensor intervals are 50 to 400 meters. Commonly used inline and crossline sensor station intervals give sensor station densities of 160 to 800 sensor stations per square kilometer. FIG. 1 is a 2D common shot gather where the sensor station spacing was reduced from 5 to 1.25 meters for a portion of the 2D line. The only energy evident in this figure is interface energy which is highly aliased using a 5 meter sensor station spacing. Using 1.25 meter sensor station spacing eliminates spatial aliasing for more frequencies and allows the correct apparent velocity of the energy to be computed. Eliminating spatial aliasing allows this undesired energy mode to be adequately isolated and attenuated by traditional seismic data processing methods. Sensor station spatial intervals on the order of 1 to 3 meters often allow interface waves to be isolated from much of the desired mode, especially for the typical seismic frequency band and when the earth is plane layered. For a 3D survey with uniform inline and crossline sensor station intervals, a 1 meter sensor station interval would require one million sensors per square kilometer. Increasing the sensor station interval to 3 meters would require in excess of one-hundred thousand sensor stations per square kilometer. Considering that 3D seismic spreads typically cover six to twenty square kilometers, these small sensor station intervals would require millions of active sensor stations. Even if the underlying equipment reliability would support large sensor station counts, the operational cost and environmental impact would be unacceptable, and the data volumes would be prohibitively large.

Seismic acquisition employs several methods to assist in the goal of mode separation. Source and receiver arrays are commonly used with a primary purpose of rejecting undesirable spatial frequencies. However, arrays do not explicitly discriminate between modes; rather, they filter all modes, and as such are not accomplishing mode separation. Arrays can be helpful in mode separation if the undesired mode(s) consists exclusively of spatial frequencies rejected by the array, while the desired mode(s) consists exclusively of spatial frequencies passed by the array. However, this condition is rarely fully satisfied. Desired mode(s) frequently consist of a broad range of spatial frequencies, especially when the earth structure is complex. Furthermore, intra-array statics and other non-ideal aspects have the effect of substantially broadening the spatial frequency content of desired mode(s). Consequently, arrays are known to substantially attenuate desired mode(s) as well, particularly at higher frequencies.

Seismic acquisition also uses multicomponent methods to assist in the goal of mode separation. Multicomponent marine acquisition usually consists of a compressional wave marine source, such as air guns or marine vibrators, and ocean bottom cables containing hydrophones and translational motion sensors (geophones or accelerometers). Use of ocean bottom cables containing hydrophones and motion sensors measuring vertical translation is often referred to as two component, or 2C acquisition. Use of ocean bottom cables containing hydrophones and motion sensors measuring vertical and two orthogonal perpendicular horizontal translations is often referred to as four component, or 4C acquisition. Multicomponent land acquisition usually consists of conventional land sources such as buried dynamite or vertically translating vibratory source, but uses motion sensors measuring vertical and two orthogonal horizontal translations (geophones or accelerometers). This is often referred to as three component, or 3C acquisition. In addition to a vertically translating vibratory source, horizontally translating vibratory sources (Bird (2000) U.S. Pat. No. 6,065,562) (Owen (2000) U.S. Pat. No. 6,119,804) are sometimes used, respectively, at the same source location. This approach is referred to as nine component, or 9C seismic acquisition (Alford (1989) U.S. Pat. No. 4,803,666).

Multicomponent seismic data is used for a variety of purposes including, under important assumptions, an approximate mode separation. However, 2C seismic data is often used to separate up propagating from down propagating compressional waves, which leads to applications such as de-ghosting and free-surface multiple removal (Robertsson (2004) U.S. Pat. No. 6,775,618). Separation of up propagating and down propagating compressional waves is often referred to as “wavefield separation”. Wavefield separation and mode separation are different in that mode separation involves separation of different modes of wave propagation, whereas wavefield separation involves separation of two or more waves of a single mode propagating in different directions. Tenghamn (2007 U.S. Pat. No. 7,239,577 B2) proposes 2C acquisition by pressure and translational motion sensors in a streamer. Tenghamn refers to pressure sensors as “pressure gradient sensors”. This should not be confused with usage of the term “pressure gradient” herein, where it is intended to refer to a spatial derivative of pressure. Amundsen (2007, U.S. Pat. No. 7,286,938) generalizes for up and down propagating separation of longitudinal and shear waves in an elastic medium using multicomponent sources and receivers. 3C seismic data is often used to separate longitudinal waves from shear waves under the assumption that seismic waves are vertically propagating plane waves to the earth's surface; therefore, the longitudinal wave registers as vertical translational motion and the shear wave registers as horizontal translational motion. 4C seismic data is often used for both purposes of separating up and down propagating compressional waves, and separating longitudinal and shear plane waves arriving vertically from the earths subsurface to the sea bottom. Applications using 9C seismic data often assume the same conditions of 3C seismic data on the receiver side, and assume vertically emanating waves from the source. For this reason, vertically translating vibratory sources are often referred to as compressional, longitudinal, or P-wave sources, whereas horizontally translating vibratory sources are often referred to as shear or S-wave sources. Many methods exist for horizontally translating vibratory sources (e.g., Erich (1982) U.S. Pat. No. 4,327,814). However, no matter the orientation, translational vibratory sources on land always emanate a variety of modes including both P- and S-waves, even in an ideal homogeneous, isotropic, elastic medium or half space. Examples of 9C common source point gathers are shown in FIG. 2. The figure contains data from a 2D line of 3C seismic sensors where the vibratory sources had a minimal perpendicular offset from the sensor line. When the energy from a vertically oriented vibratory source is recorded on a 3C seismic sensor, significant energy is measured on all components, not just the vertically oriented sensor. Correspondingly, a horizontally oriented vibratory source whose axis of motion is parallel or perpendicular to the direction of the 3C sensor line generates significant energy on all components of the 3C receivers. Clearly the orientation of a translational motion vibratory energy source generates different signals on 3C seismic sensors; but 9C seismic acquisition does not uniquely isolate or exclude the recording of specific energy modes. Hardage (2004, U.S. Pat. No. 6,831,877) and Gilmer (2003, U.S. Pat. No. 6,564,150) propose source and sensor methodology to align horizontal translational axes of sources and receivers to improve the separation of modes. In practice, even with 3C seismic sensors and 3C sources, the energy on a given sensor component cannot be uniquely associated with a given mode of wave propagation.

A tacit assumption of commercial seismology has been that translational motions recorded on 3C seismic receivers allow the seismic wavefield to be fully characterized. However, there are additional degrees of freedom of ground motion that may have informational value useful for mode separation. Consider the seismic wavefield represented by the function v(x,y,z), where v is a vector quantity corresponding to translational motion, such as displacement, particle velocity, or particle acceleration. A vertical geophone would measure v_{z}, and the two horizontal geophones would measure vₓ and v_{y} to yield 3-components of motion. There are 9 gradients (spatial derivatives) of the three translations in the three spatial directions given by:

$$\begin{matrix}\frac{\partial {v}_{z}}{{\partial }_{z}} , \frac{\partial {v}_{z}}{{\partial }_{x}} , \frac{\partial {v}_{z}}{{\partial }_{y}} & \frac{\partial {v}_{x}}{{\partial }_{z}} , \frac{\partial {v}_{x}}{{\partial }_{x}} , \frac{\partial {v}_{x}}{{\partial }_{y}} & \frac{\partial {v}_{y}}{{\partial }_{z}} , \frac{\partial {v}_{y}}{{\partial }_{x}} , \frac{\partial {v}_{y}}{{\partial }_{y}}\end{matrix} \qquad ( 1 )$$

Ideally, the gradient in the x direction can be approximated by subtracting traces from adjacent stations at x₂ and x₁ as:

$$\begin{matrix}\frac{\partial {v}_{z}}{\partial x} \approx \frac{{v}_{z} ( {x}_{2} ) - {v}_{z} ( {x}_{1} )}{{x}_{2} - {x}_{1}} & \frac{\partial {v}_{y}}{\partial x} \approx \frac{{v}_{y} ( {x}_{2} ) - {v}_{y} ( {x}_{1} )}{{x}_{2} - {x}_{1}} & \frac{\partial {v}_{x}}{\partial x} \approx \frac{{v}_{x} ( {x}_{2} ) - {v}_{x} ( {x}_{1} )}{{x}_{2} - {x}_{1}}\end{matrix} \qquad ( 2 )$$

and similar approximations can be made for the y and z directions. Then, the curl c(x,y,y,t) can be computed:

$$( \begin{matrix}{c}_{x} \\ {c}_{y} \\ {c}_{z}\end{matrix} ) = \frac{1}{2} ( \begin{matrix}\frac{\partial {v}_{z}}{\partial x} - \frac{\partial {v}_{y}}{\partial z} \\ \frac{\partial {v}_{x}}{\partial z} - \frac{\partial {v}_{z}}{\partial x} \\ \frac{\partial {v}_{y}}{\partial x} - \frac{\partial {v}_{x}}{\partial y}\end{matrix} ) \qquad ( 3 )$$

Note that curl can be computed by subtracting gradients. Divergence could also be computed from (2) above. Existing approaches to capture these additional degrees of freedom tend to use subtraction of closely spaced, or clustered, translational motion sensors. Menard (2009, U.S. Pat. No. 7,474,591 B2) uses 6 translational receivers to approximate the gradients and then the rotations, calling the output of 3 translations plus 3 rotations a 6 component system. Tokimatsu (1991, EP 0 455 091 A2) and Curtis and Robertsson (2001, GB 2 358 469; 2001, GB 2 358 468; 2004 U.S. Pat. No. 6,791,901 and 2001 EP 1 254 383 B1) propose using locally dense sensor arrangements at each sensor station, and utilize typical sensor station spacing. However, approximating spatial derivatives using translational sensors involves subtracting two large signals (the translation) to get a much smaller one. This can be very difficult to implement in practice for several reasons. One problem is that the sensors must be precisely matched for good common mode rejection. In addition, the different sensors must be separated a precise distance apart along the same horizon. Third, the earth must not change properties between the different elements to be subtracted. Fourth, the coupling of each sensor to the earth must be identical. Also, the presence of random noise makes signal-to-noise much worse after subtraction.

Similarly, there are inventions in which spaced, or clustered, pressure sensors are used to compute spatial gradients of pressure for various applications. For example, pairs of receivers at different depths have been proposed for wavefield separation (separation of up and down propagating compressional wave) and deghosting (Loewenthal (1988) U.S. Pat. No. 4,752,916), (Robertsson 2001, EP 1 254 383 B1; 2008, EP 1 703 303 A2; 2003, US 2003/0147306; and 2001, GB 2 358 468 A), (Curtis and Robertsson, 2001, GB 2 358 469), (Paffenholz, 2001, U.S. Pat. No. 6,188,963). Problems with unmatched sensors, precisely positioning the streamers vertically apart, and noise, effect limitations on wavefield separation by these methods. Another example uses a plurality of pressure sensors (hydrophones) in a well to perform mode separation of compressional waves, shear waves and tube waves. Muyzert (2008/0316860 A1) employs pairs of pressure sensors and computes pressure gradient by subtraction. Rice (1988, U.S. Pat. No. 4,789,968) uses dipole hydrophones (i.e. two sensors that are subtracted) to record compressional waves and not tube waves (FIGS. 4A-C) in a well. FIG. 4A is a schematic diagram of the elements of a pair of orthogonal hydrophones. An example using piezoelectric dipole hydrophones is shown in FIG. 4B. FIG. 4C shows a perspective view of a seismic streamer deployed in a borehole. Both compressional waves and tube waves cause modulation of pressure, so a pressure sensor (e.g., a hydrophone) registers both modes. A property of tube waves is symmetry of pressure from the borehole center. Rice's method relies on the subtraction of signals from two hydrophones located symmetrically around the borehole axis (for example, poles A and B in FIG. 4A). The subtraction mitigates the tube wave, but also has undesirable effects on the compressional wave. Additionally, hydrophones on opposite sides of the borehole must be well matched to achieve adequate common-mode rejection. This has proven to be a difficult condition to achieve reliably and repeatedly.

Seismic data acquisition sensors and sources have been proposed that are neither pressure nor translational, but respond to gradients and curl directly. An example is a pressure gradient transducer (Meier, 2007, U.S. Pat. No. 7,295,494). The earthquake seismology community has recognized informational value of an additional three degrees of freedom of ground motion; rotational motion about each of three mutually orthogonal axes (Graizer 2005 & 2006, Trifunac 2001, Nigbor 1994). Cowles (1984, U.S. Pat. No. 4,446,541) discloses a rotational geophone measuring rotation about a single axis used in combination with a single translational motion sensor. Similar devices have been employed for various applications in other industries. Analog Devices builds a 6C device, the ADIS 16362 which is a triaxial inertial sensor that provides three dimensional particle motion measurement and three dimensional rotational measurements. Similarly, for sources, Won (1982, U.S. Pat. No. 4,310,066) discloses an impulsive torsional shear wave generator intended to produce horizontally polarized seismic shear waves. However, compressional and shear impulsive sources also generate multiple energy modes. A controlled vibratory seismic source using a rotating eccentric mass is described by Cole (1992, U.S. Pat. No. 5,166,909; 1993, EP 0325029 B1). However, the source described by Cole imparts both angular momentum and compression on the medium and initiates both shear and compressional waves.

There is a need for acquisition methods that provide improved specificity or separation of individual modes of propagation without using dense sampling or local dense sampling. In particular, problems with common mode rejection by subtracting large and nearly equal signals recorded with translational or pressure sensors to obtain this specificity or separation should be avoided.

### SUMMARY OF THE INVENTION

The invention relates to a method of seismic data acquisition that uses sensors that respond selectively to a desired mode or have mode dependent responses, and/or sources capable of initiating a single mode or groups of modes whose energy distributions can be made to differ in a desirable way, as a means to separate various seismic energy modes. The invention accomplishes mode separation in seismic data acquisition, as opposed to seismic data processing. Unlike seismic processing methods for mode separation that rely on travel time between source and sensor, apparent velocity, spatial frequency, or other space-time relationships in one or more spatial domains, the invention can accomplish mode separation in seismic acquisition by selective use of sensor and/or source types. The invention does not rely on information from adjacent locations of sources and/or sensors to accomplish mode separation, as in seismic processing, but achieves mode separation for each source and sensor location, independently.

An example of a sensor that can be used to separate body waves in the present inventive method is a sensor that is sensitive to shear waves but is insensitive to compressional waves. Examination of the inherent nature of shear and compressional waves and how they differ from one another can suggest a design for such a sensor. For example, shear waves are a transference of angular momentum but do not involve compression of the medium. (Mathematically, the curl of displacements in the medium is nonzero, whereas the divergence of displacements is zero.) Compressional waves compress the medium producing pressure modulation but do not torque the medium. (Mathematically, the divergence of displacements in the medium is nonzero, whereas the curl of displacements is zero.) Consequently, a sensor that registers modulation of angular momentum or rotation but does not register modulation of pressure is selectively sensitive to shear waves. Contrastingly, a sensor that registers pressure modulation but does not register angular momentum or rotation is selectively sensitive to compressional waves.

Sensors that respond selectively to a desired mode may be designed. Such sensors are distinctive from translational motion sensors (e.g., geophones and accelerometers) because translational motion is an attribute of all modes. Consequently, translational motion sensors do not distinguish between modes, but register all modes. This invention does not include methods that use translational motion sensors to determine translational motion relative to direction of propagation, as in 3C multicomponent acquisition for example, as a means to separate compressional and shear waves. Because the seismic wavefield is complex and may include many modes of wave propagation from many directions concurrently, these methods that rely on translational motion sensors are often problematic.

The invention avoids problems associated with subtracting signals from closely spaced sensors of a locally dense array. Additionally, the ability to selectively measure a desired mode at an individual sensor station allows the sensor station interval (receiver sampling) to be chosen only on requirements to adequately sample the desired mode. In contrast, conventional seismic acquisition must adequately sample all modes used in seismic processing, including mode separation processing. As described previously, this can impose an onerous sampling requirement that cannot be fully satisfied in practice, resulting in limited processing performance and substantial errors or noise.

An example of a source that can be used in the present invention is a source that imparts angular momentum, but not compression, on the medium. Such a source buried in an elastic medium that is homogeneous and isotropic in the vicinity of the source does not compress the medium but only torques the medium. (Mathematically, the curl of nearby displacements in the medium caused by the source is nonzero, whereas the divergence of displacements is zero.) Such a source selectively initiates shear waves into the medium. Contrastingly, a source that imparts compression, but not angular momentum, on the medium does not torque the medium. (Mathematically, the divergence of nearby displacements in the medium caused by the source is nonzero, whereas the curl of displacements is zero.) Such a source selectively initiates compressional waves into the medium. A more general source that may be used as part of the invention controls all components of longitudinal and angular momentum imparted on the earth resulting in controlled energy partitioning of various modes.

Sources that selectively initiate a desired mode may be designed. Such sources are distinctive from translational vibratory sources (e.g., vertically and horizontally translational vibratory sources) because translational motion is an attribute of all modes. Consequently, translational sources do not selectively initiate desired modes, but initiate many modes. This invention does not include methods that use translational vibratory sources to impart translational momentum relative to direction of propagation, as in 9C multicomponent acquisition for example, as a means to selectively originate compressional or shear waves. Because translational vibratory sources, regardless of orientation, excite many modes of wave propagation in many directions concurrently, these methods are often problematic.

In at least some of it embodiments, the invention involves use of mode selective sensors or sensor sets possibly coupled with mode selective sources or source sets. The seismic data obtained by a successful implementation of the invention contain fewer modes of wave propagation, or at least a different energy weighting of modes, than seismic data obtained by conventional acquisition. Which modes are well measured and enhanced in the seismic data and which modes are attenuated in, or excluded from, the seismic data depends on the particular implementation of the invention. If the mode that is desired (e.g., for the purposes of imaging and inversion) is included or enhanced in the seismic data, and has dominant amplitude over other modes in the seismic data, then mode separation processing may not be necessary; as the mode has been successfully separated in acquisition by use of the invention. If other modes have comparable or greater amplitudes to the desired mode, then some mode separation processing may be needed as well. In other words, use of the present inventive method does not necessarily preclude further improvement in mode separation by data processing methods.

In others of its embodiments, the present inventive method selectively captures or enhances one or more undesired mode(s). The seismic data obtained by this embodiment of the invention may be used to better characterize the undesired mode(s) for removal from other seismic data sets acquired over the same location, possibly concurrently. The other seismic data sets may be obtained by conventional acquisition or by other embodiments of the invention. When an embodiment of the invention that enhances the undesired mode(s) is used, they may be subtracted (perhaps after weighting) from the other data set(s) in order to remove the undesired mode(s) from the other data set(s). Processes other than subtraction or weighted subtraction may also enable use of the first data set containing the undesired mode(s) to selectively remove the undesired mode(s) from the other data set(s).

In one embodiment, with reference to the flowchart of FIG. 6, after first selecting a desirable seismic mode (61) over an undesirable seismic mode (62), the invention is a method for acquiring mode-separated seismic data, comprising recording seismic energy (64), transmitted through a medium to one or more sensors in a plurality of seismic energy modes, wherein all sensors preferentially record a selected one of said seismic energy modes and do not detect translational motion (63), resulting in mode-separated seismic data (65). Some embodiments of the invention also use a seismic source that preferentially transmits the selected seismic energy mode (63).

A variation of this method involves: recording a first data set of seismic energy transmitted from a first seismic source through a medium in a plurality of modes comprising a first mode and a second mode; recording a second data set of seismic energy transmitted from a second seismic source through the medium either in a single mode being the first mode, or in a plurality of modes comprising the first mode and the second mode but with a different energy distribution between the modes than for the first seismic source; and separating the first and second modes by a combination of the two data sets.

### BRIEF DESCRIPTION OF THE DRAWINGS

The present invention and its advantages will be better understood by referring to the following detailed description and the attached drawings in which:

FIG. 1 shows an example of 2D sensor stations using medium and high density spatial sampling;

FIG. 2 shows a set of common source point records from a 9C seismic data set;

FIGS. 3A-B show applications of single well profiling including (FIG. 3A) locating the salt flank, and (FIG. 3B) positioning horizontal wells;

FIGS. 4A-C illustrate crossed dipole hydrophone streamers as described by Rice, with a schematic diagram of the elements of a pair of orthogonal hydrophones shown in FIG. 4A, an embodiment of piezoelectric dipole hydrophones is shown in FIG. 4B, and a perspective view of a seismic streamer deployed in a borehole shown in FIG. 4C;

FIG. 5 shows an example of mode separation to enhance a raw seismic data shot; and

FIG. 6 is a flowchart showing basic steps in one embodiment of the present inventive method.

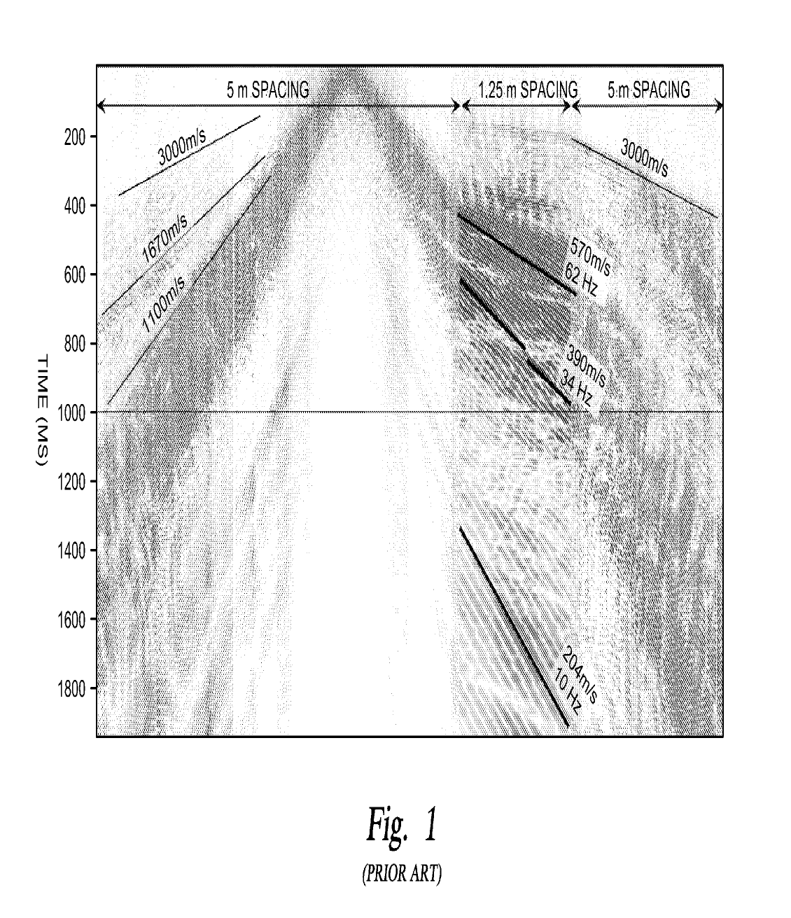

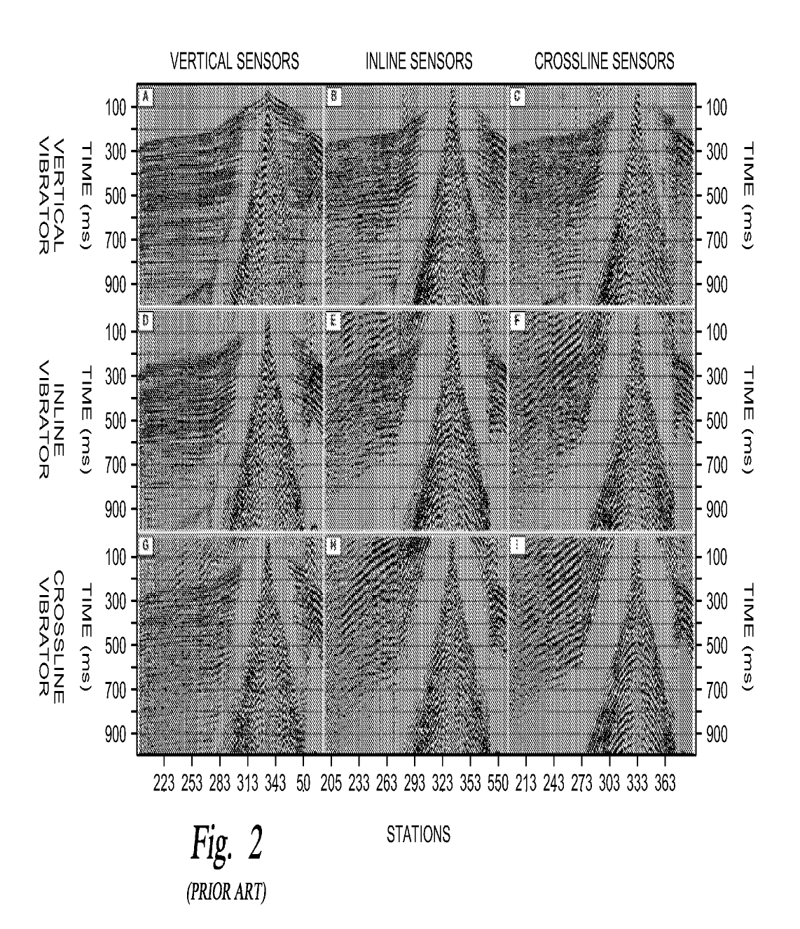

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

One embodiment of the invention relates to mode separation in 2C ocean bottom acquisition to distinguish compressional waves, i.e. to separate P-waves from S-waves. The embodiment uses two collocated sensor types, each selectively sensitive to compressional waves and not sensitive to shear waves, for 2C seismic acquisition. One sensor type is a pressure sensor, for example a hydrophone as used in conventional 2C acquisition. A second sensor type is a pressure gradient sensor, for example one as disclosed by Meier (2007, U.S. Pat. No. 7,295,494), oriented to measure the vertical component of pressure gradient. This embodiment has considerable mode distinguishing advantage over conventional 2C ocean bottom cable (OBC) acquisition that uses a hydrophone and vertically oriented translational motion sensors (geophones or accelerometers) to measure pressure modulation and modulation of vertical translational motion, respectively. The hydrophone is a pressure sensor and is, therefore, selectively sensitive to compressional waves. However, geophones and accelerometers are translational motion sensors and, therefore, are not selectively sensitive to compressional waves. Consequently, additional modes captured in the vertical sensors cause error when using the 2C data to separate up and down propagating compressional waves. However, application of the described embodiment of the invention enables 2C seismic acquisition that avoids the undesired modes recorded by vertical translational motion sensors. Recordings from pressure sensors and pressure gradient sensors may be used in combination to separate up and down propagating compressional waves (which are not different modes). Because both sensor types are selectively sensitive to compressional waves, contamination by other modes is avoided.

The previously described embodiment may also be applied in settings other than ocean bottom seismic acquisition. For example, collocated pressure and pressure gradient sensors may also be used in seismic marine streamers, borehole, and vertical seismic profiling (VSP) applications.

In many settings, compressional wave propagation may not be restricted to upward and downward propagation, but may propagate in non-vertical directions. Because pressure is a scalar quantity, a pressure sensor is unaffected by direction of propagation of a compressional wave. However, pressure gradient is a vector quantity and is affected by a compressional wave's direction of propagation. A complete measurement of the pressure gradient of a compressional wave propagating in an arbitrary direction requires three or more collocated pressure gradient transducers with different orientations. For example, recordings from three collocated pressure gradient transducers oriented in three mutually orthogonal directions can be vector summed to obtain the pressure gradient of a compressional wave propagating in any direction. A pressure sensor collocated with three mutually orthogonal pressure gradients sensors is an embodiment of the invention that can also be used for ocean bottom seismic acquisition to selectively measure compressional waves. Then, the measurements of pressure and pressure gradient of compressional waves, uncontaminated by other modes, can be used in existing wavefield separation processes to separate compressional waves according to direction of propagation. This embodiment of the present invention can be used similarly in settings other than ocean bottom seismic acquisition; for example, marine streamers, borehole, and vertical seismic profiling applications.

Another embodiment of the invention combines the prior embodiment, to selectively measure the compressional wave, with sensors that selectively exclude the compressional wave and measure other modes, such as shear waves. Sensors sensitive only to angular momentum or rotational motion (referred to herein as “rotational sensors”) are insensitive to compressional waves, but are sensitive to other modes such as shear waves. Rotational sensors can be located on the ocean bottom, within the ocean bottom mud, or buried beneath the ocean bottom. Three collocated rotational sensors can be used to measure rotational motion about each of three mutually orthogonal axes. The embodiment may include this configuration of rotational sensors collocated with configurations of pressure and pressure gradient sensors described in prior embodiments. Therefore, the embodiment produces recordings that include the compressional wave but exclude other modes, and recordings that exclude the compressional wave but includes other modes, including shear waves. Consequently, the embodiment accomplishes mode separation by means of acquisition method, an objective of the present invention. The embodiment has advantages over conventional 4C OBC acquisition that uses a hydrophone collocated with three geophones (or accelerometers) oriented to measure translational motions in each of three mutually orthogonal directions. A common application of 4C seismic data uses hydrophones and vertical geophones to infer the compressional wave, and horizontal geophones to infer the shear wave. However, geophones and accelerometers are translational motion sensors and, therefore, are not selectively sensitive to compressional or shear waves, no matter their orientation. Horizontal geophones will also register compressional waves travelling at some angle to the vertical. Other modes, such as interface modes travelling along the earth-water interface, may also register. Consequently, inferring shear waves from horizontal geophones can be difficult and include substantial noise or error. Rotational sensors have advantage over horizontal geophones because they do not register compressional waves, even those travelling at an angle from the vertical.

The previously described embodiment may also be applied in settings other than ocean bottom seismic acquisition. For example, collocated rotational, pressure, and pressure gradient sensors may also be used in land seismic acquisition, borehole, and vertical seismic profiling (VSP) applications.

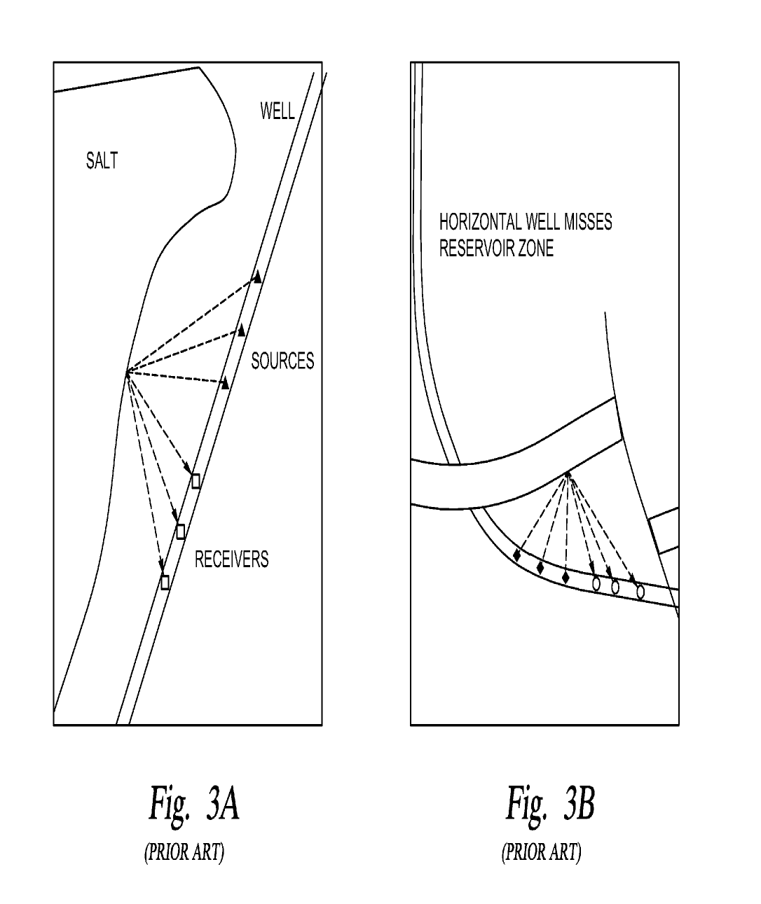

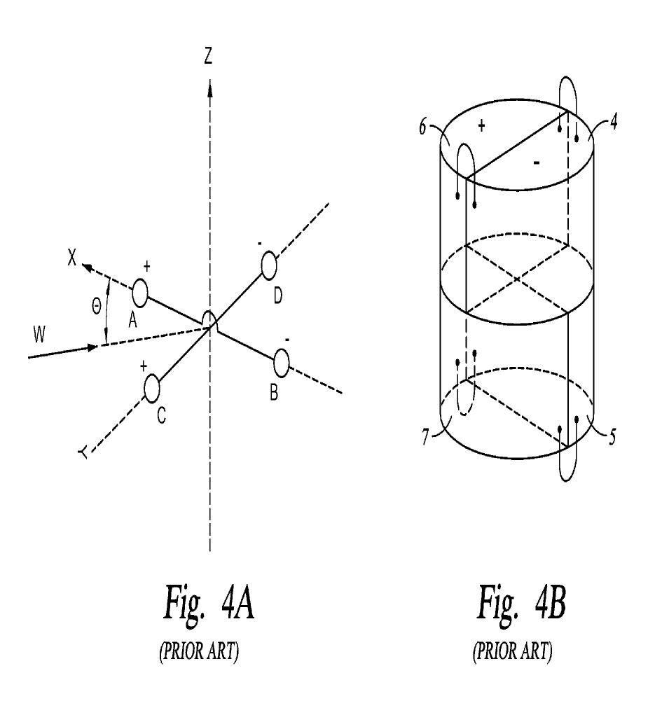

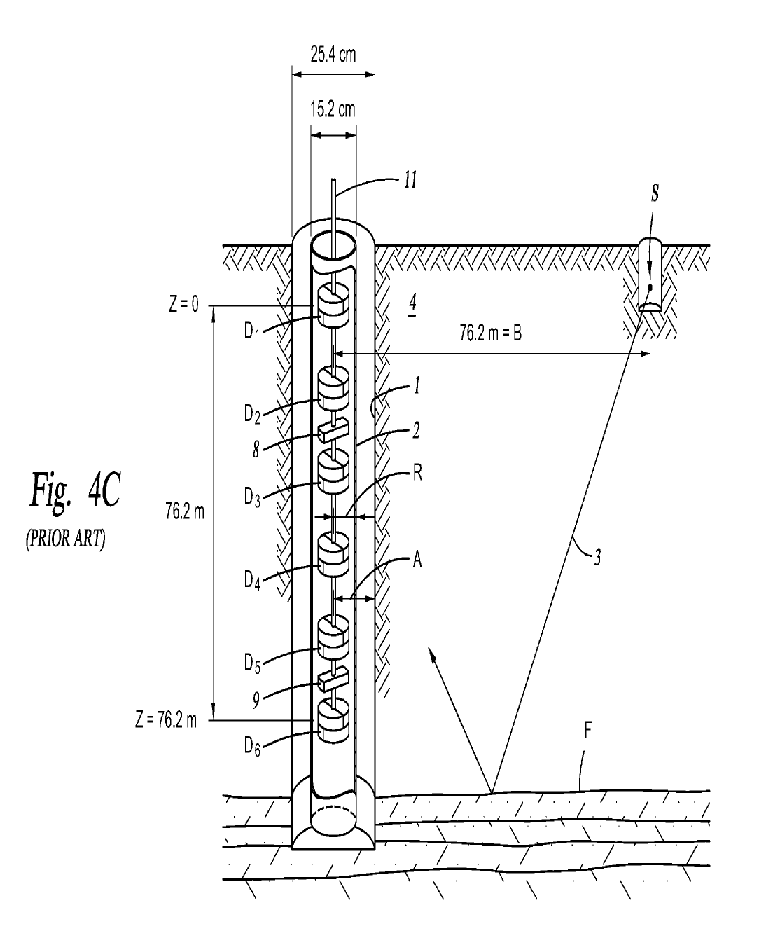

In another embodiment, the inventive method can separate compressional waves from tube waves in a borehole environment. This embodiment uses sensors that are sensitive to the desired compressional body wave, but insensitive to the tube wave. Consequently, it does not rely on subtraction of signals to mitigate an undesired mode. Near the borehole center, pressure modulation from the tube wave is very large, but pressure gradient modulation from the tube wave is small or zero. In contrast, a compressional body wave travelling from the formation through the borehole substantially modulates the pressure gradient. This embodiment uses pressure gradient sensors in a borehole setting. The pressure gradient sensors may be for example as disclosed by Meier (2007, U.S. Pat. No. 7,295,494), oriented perpendicularly to the borehole axis in place of, for example, the previously known hydrophone configurations shown in FIG. 4. The sensors record modes associated with compressional body waves in the formation and not the fundamental or other symmetrical tube-wave modes. The tool may also incorporate a means to center the tool within the borehole, especially for horizontal wells. Since low-frequency tube waves are symmetric around the borehole axis, they have no pressure gradient at the borehole center where the sensors are located and will not be recorded. Higher-order non-symmetrical tube waves are not in the seismic band and can be eliminated by high cut filtering. The receiver system can be used for many borehole applications, including single-well profiling, VSP, and crosswell applications. Two examples of single-well profiling are illustrated in FIGS. 3A-B. Because of the short range to the target and high operating frequencies, high resolution 2D images of the near-well formations can be obtained. The applications illustrated are locating the salt flank in FIG. 3A and positioning horizontal wells in FIG. 3B. Single-well profiling is not feasible with current technology because the tube wave modes generated in the borehole fluid are much larger than reflections.

The invention also relates to the use of sources in seismic acquisition that initiate a single mode or groups of modes whose energy distributions can be made to differ in a desirable way. An embodiment of the invention may distinguish modes at least partly by use of a source that imparts angular momentum, but not compression, on the medium thereby selectively initiating modes not including compressional waves. Furthermore, a preferable controlled vibratory source might be one that can apply torque about any one of three mutually orthogonal axes, as chosen, and not be restricted to torque about the vertical axis only. Such a source is not widely available, but could be developed from the disclosures herein. The source can be used with any type of sensor, including conventional sensors or mode selective sensors. Because the source initiates modes of wave propagation (or groups of modes with energy distributions) that are different from other sources, the earth response will be different. The different earth responses may be used or combined to enhance or mitigate desired modes. A simple example is to use an angular momentum source in combination with angular momentum sensors. A seismic data set acquired with this pair of source-sensor types preferentially records SS body waves. The embodiment has advantages over conventional acquisition using horizontally translating vibratory sources and motion sensors measuring horizontal translations (horizontally oriented geophones or accelerometer), which is commonly referred to as SS seismic acquisition. However, the conventional method does not use either mode selective sources or mode selective sensors, and includes many more modes other than SS. For example, a horizontally translating vibratory source also produces compressional waves, and horizontally oriented geophones and accelerometers also record translational motion caused by compressional waves. Therefore, PP, SP, and PS modes are also present in recordings using the traditional method, but are absent in recordings using the described embodiment.

Similarly, embodiments of the invention may accomplish mode separation in acquisition by using an angular momentum source and pressure sensors and/or pressure gradient sensors to preferentially record SP body waves. Embodiments of the invention may use sources imparting compression on the medium, but not angular momentum, in combination with angular momentum sensors to preferentially record PS body waves; or use the same source in combination with pressure and/or pressure gradient sensors to preferentially record PP body waves. Uniformly explosive sources, air guns, and marine vibrators are examples of such seismic sources. In land seismic acquisition, the described source is mode selective because many modes can be initiated by a source acting on the land. However, in marine seismic acquisition, the water medium supports only compressional waves, so a source imparting only compression or a sensor that is sensitive only to compression is not considered to be mode selective in this situation. In other words, with respect to the attached claims, using a mode selective source or sensor is not considered to be acquiring mode separated seismic data by use of certain sensors or sources if there is only one mode supported near the source or sensor to begin with, such as where the medium supports only a single mode. Many combinations of source and sensor types, including combinations containing both mode selective and conventional types, are possible and may be useful for separating modes. Seismic data collected with different source-sensor pairs could be combined to enhance or mitigate desired modes.

The methods disclosed herein may be used to study the earth response and determine information about the subsurface. Additionally, they may be used to study complicated modes, and derive mode selective sources, sensors, or methods to separate those modes besides those that are explicitly presented as examples herein. Ground roll encountered in land seismic acquisition is an example of complicated modes, and combinations of modes. A study of the ground roll using the described methods may determine mode selective sensors, such as those previously discussed or others, that could be designed to selectively register ground roll, or selectively register body waves in the presence of ground roll. Additionally, sets or combinations of mode selective sensors, sets or combinations of mode selective sensors and translational motion sensors, etc., occupying a single sensor station, could be designed to allow the energy associated with ground roll and the energy associated with body wave reflections to be unambiguously identified on a sensor station by sensor station basis. Use of the designed sensor, sensor sets, or sensor combinations to this purpose, or to otherwise selectively separate, mitigate, or enhance ground roll, are within the scope of the present invention. Such embodiments have advantages over traditional methods that use seismic processing methods to mitigate ground roll and require small station spacing for adequate sampling. Since the methods disclosed herein do not require information from adjacent sensor stations to unambiguously identify energy associated with the energy modes that make up the ground roll, the sensor station spacing need depend only on the imaging requirements for the body wave reflections.

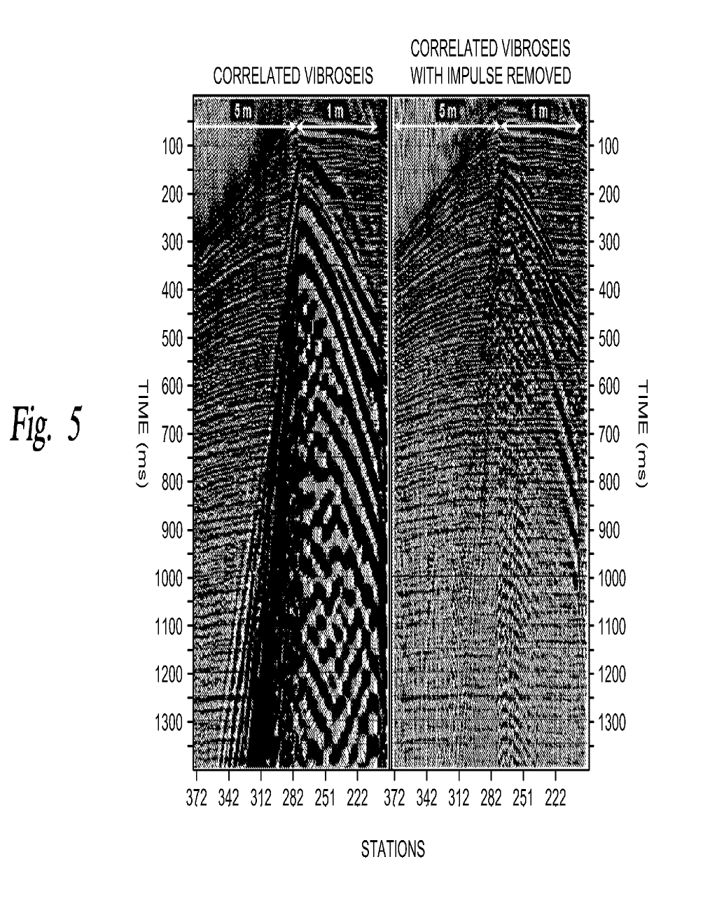

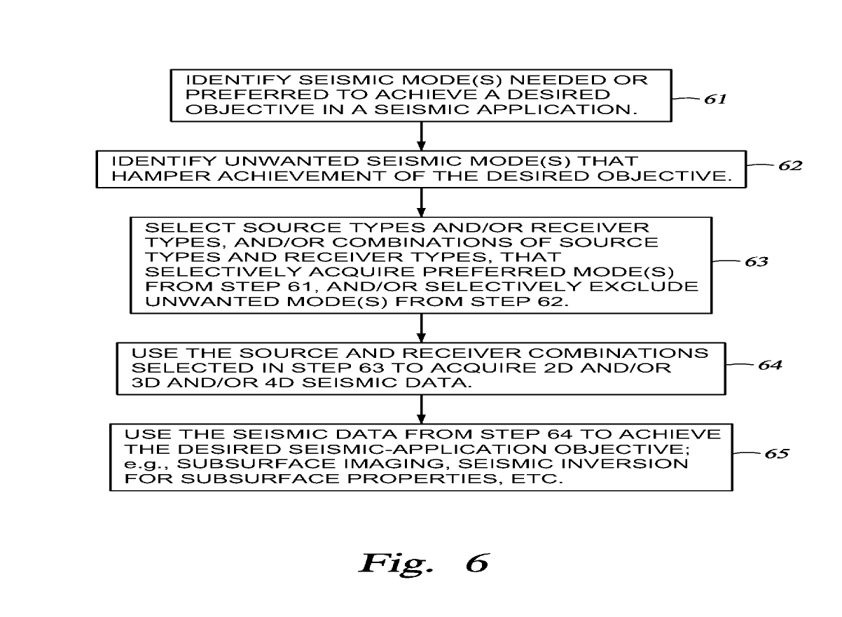

Another method of this disclosure separates body waves from ground roll by using seismic sources that initiate a single mode or groups of modes whose energy distributions can be made to differ in a desirable way. Conventional seismic sources used on land at the earth's surface are known to generate body waves and ground roll. Ideally, a seismic source is wanted that would generate body waves, but not ground roll. Alternatively, a source that generates ground roll, but not body waves, could be used to acquire a seismic data set that includes substantially only ground roll. Another seismic source that generates both body waves and ground roll may be used to acquire a second seismic data set over the same location. The first seismic data set containing substantially only ground roll can be used to eliminate or mitigate the ground roll in the second seismic data set, leaving substantially only body waves. For example, the first seismic data set might be subtracted (perhaps after weighting) from the second seismic data set. A more practical set of sources might include two source types that each generate both body waves and ground roll, but one source generates body waves and ground roll with a substantially different energy proportion than the other source. A weighted subtraction of seismic data sets obtained using the two sources, respectively, could be used to eliminate or mitigate the ground roll. In this case, the body waves may also be attenuated somewhat, but the ground roll is attenuated more strongly and may be eliminated. An example of source-side mode separation is shown in FIG. 5. The left-hand trace display is a correlated vibroseis record showing data from a 2D line. For both of the trace displays shown in FIG. 5, the sensor station interval for the leftmost sensors is 5 m. The sensor station interval for the rightmost sensors is 1 m. The 1-m sensor station interval allows the detail within the ground roll cone to be seen. The trace display on the right hand side was generated by acquiring a vibroseis record, acquiring a vibrator impulse at the same source point, appropriately processing the vibrator impulse record and subtracting the vibrator impulse record from the correlated vibroseis record. The original correlated vibroseis record is shown in the left hand side of the figure. A vibrator impulse is created by driving the vibrator with an impulsive reference signal instead of a swept frequency signal. By its nature, a typical seismic vibrator can deliver only a limited amount of energy when it is driven with an impulsive reference signal. Because of the limited energy available, the vibrator impulse generates little or no recoverable body wave reflection energy; but it does generate a significant amount of interface wave energy. The differences in the energy modes created by an impulse signal and a swept frequency signal allow the energy in the ground roll to be selectively attenuated. As can be seen by the right hand trace display, subtracting the vibrator impulse from the correlated vibroseis record significantly attenuates the energy associated with the ground waves and allows the body wave reflections to be seen.

Many other methods of mode separation in acquisition are possible and will be suggested to the skilled reader by the examples presented herein. All such methods are considered to be within the scope of the present disclosure, and within the attached claims according to their terms. The choice of which sensor type, or sets of sensor types, to combine with which source type, or sets of source types, is dictated by the mode or modes that are desired and the particular seismic acquisition environment (e.g., land, borehole, or ocean bottom).

Data acquired by a method disclosed herein may contain a single mode, or a subset of modes hosted by the medium. Data from different methods disclosed herein or different embodiments of the present invention may contain different modes or different subsets of modes, or may contain one or more modes in common The data may be combined to further separate modes. Seismic processing methods may be applied to data that contains more than one mode to further isolate, enhance, or mitigate a desired mode. The data, which may be processed data, can be used for imaging or inversion, or to otherwise determine physical structure or properties of the subsurface. The data may also be used for other applications, such as joint inversion or full wavefield inversion.

Example embodiments of the present disclosure include:
1. A method for separating shear mode from compressional mode in acquisition of seismic data, comprising using a rotational sensor co-located with either a pressure sensor or a pressure gradient sensor, wherein none of the aforementioned sensors detect translational motion.
2. A method for acquiring data associated with a single seismic energy mode, either S-S, S-P, P-S or P-P, from converted wave seismic response, comprising:

for S-S data, using a seismic source that preferentially transmits S-wave seismic energy and a seismic sensor that preferentially records S-wave seismic energy;

for S-P data, using a seismic source that preferentially transmits S-wave seismic energy and a seismic sensor that preferentially records P-wave seismic energy;

for P-S data, using a seismic source that preferentially transmits P-wave seismic energy and a seismic sensor that preferentially records S-wave seismic energy;

for P-P data, using a seismic source that preferentially transmits P-wave seismic energy and a seismic sensor that preferentially records P-wave seismic energy;

wherein none of the aforementioned seismic sensors detect translational motion.
3. A method for rejecting tube waves and recording compressional waves in borehole seismic data acquisition, comprising locating a pressure gradient sensor on the borehole's centerline.
4. An ocean bottom cable seismic data acquisition method for acquiring P-wave data while rejecting S-wave and other non-compressional modes without data processing, and further separating up-going and down-going wave fields, said method comprising using a hydrophone and co-located pressure gradient sensor to measure the P-wave, the pressure gradient sensor oriented to measure the vertical component of pressure gradient and used with the hydrophone data to distinguish up-going from down-going P-waves.

The foregoing patent application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

### REFERENCES

Alford, R. (1989) “Multisource Multireceiver Method and System for Geophysical Exploration”, U.S. Pat. No. 4,803,666.
Amundsen, L., et al. (2007) “Method of and an Apparatus for Processing Seismic Data”, U.S. Pat. No. 7,286,938 B2.
Bird, J., et al. (2000) “System for Imparting Compressional and Shear Waves Into the Earth”, U.S. Pat. No. 6,065,562.
Cole, J., et al. (1992) “Method of Seismic Exploration Using Elliptically Polarized Shear Waves”, U.S. Pat. No. 5,166,909.
Cole, J. (1993) “Downhole Orbital Seismic Source”, EP 0325029 B1.
Curtis, A., et al. (2001) “Estimating Near-Surface Material Properties in the Vicinity of a Locally Dense Group of Seismic Receivers”, GB 2,358,469 A.
Cowles, C. (1984) “Rotational Geophone”, U.S. Pat. No. 4,446,541.
Erich, O. (1982) “Rotating Eccentric Weight Apparatus and Method for Generating Coded Shear Wave Signals”, U.S. Pat. No. 4,327,814.
Gilmer, A., et al. (2003) “System and Method for Orienting Seismic Energy Receivers to Yield Discriminated Vertical Shear Waves”, U.S. Pat. No. 6,564,150 B2.
Graizer, V. (2005) “Effects of Tilt on Strong Motion Data Processing”, Soil Dynamics and Earthquake Engineering, Vol. 25, No. 3, pp. 197-204.
Graizer, V. (2006) “Tilts in Strong Ground Motion”, Bulletin of the Seismological Society of America, Vol. 96, No. 6, pp. 2090-2102.
Hardage, B., et al. (2004) “System and Method for Determining an Azimuth of a Seismic Energy Source”, U.S. Pat. No. 6,831,877 B2.
Johnson, M., Norris, M. and Walsh, M. (2006) “Characterization of Ground Roll From a Densely Sampled 3C/3D Wavespread”, SEG 2006 Meeting Abstracts.
Kojl, T. (1991) “Methods for Measurement, Analysis and Assessment of Ground Structures”, EP 0455091 A2.
Lasse, A., Robertsson, J. (2007) “Method and an Apparatus for Processing Seismic Data”, U.S. Pat. No. 7,286,938 B2.
Loewenthal, D., et al. (1988) “Method and System for Removing the Effect of the Source Wavelet from Seismic Data”, U.S. Pat. No. 4,752,916.
Meier, M. (2007) “Diamagnetic Current Response Transducer for Sensing Pressure Gradient in a Fluid Medium”, U.S. Pat. No. 7,295,494 B2.
Menard, J., et al. (2009) “Six-Component Seismic Data Acquisition System”, U.S. Pat. No. 7,474,591 B2.
Muyzert, E., et al. (2008) “Borehole Seismic Acquisition System”, US 2008/0316860.
Nigbor, R. (1994) “Six-Degree-of-Freedom Ground-Motion Measurement”, Bulletin of the Seismological Society of America, Vol. 84, No. 5, pp. 1665-1669.
Owen, T. (2000) “Horizontally Polarized Shear-Wave Vibrator Seismic Source”, U.S. Pat. No. 6,119,804.
Paffenholz, J. (2001) “Method and System for Deriving Receiver Separation and Depth Dual Phone Seismic Surveys”, U.S. Pat. No. 6,188,963 B1.
Rice, J. (1988) “Method and System for Seismic Exploration Employing a Dual-Dipole Hydrophone Streamer”, U.S. Pat. No. 4,789,968.
Robertsson, J. and Curtis, A. (2001) “Creating a Filter for Use with Locally Dense Seismic Data”, GB 2 358 468 A.
Robertsson, J. and Curtis, A. (2001) “System and Method for Seismic Wavefield Separation”, EP 1254383 B1.
Robertsson, J. (2003) “Method of Processing Seismic Data”, US 2003/0147306 A1.
Robertsson, J., et al. (2004) “Method and System for Reducing Effects of Sea Surface Ghost Contamination in Seismic Data”, U.S. Pat. No. 6,775,618.
Robertsson, J., et al. (2004) “Seismic Detection Apparatus and Related Method”, U.S. Pat. No. 6,791,901.
Robertsson, J., Goujon, N. (2008) “Calibration of Pressure Gradient Recording”, EP 1703303 A2.
Tenghamn, S., et al. (2007) “Apparatus and Methods for Multicomponent Marine Geophysical Data Gathering”, U.S. Pat. No. 7,239,577 B2.
Trifunac, M. and Todorovska, M. (2001) “A Note on the Usable Dynamic Range of Accelerographs Recording Translation”, Soil Dynamics and Earthquake Engineering, Vol. 21, No. 4, pp. 275-286.
Tokimatsu, J., et al. (1991) “Methods for Measurement, Analysis and Assessment of Ground Structure”, EP 0455091 A2.
Vaage, S. (2004) “Method for Acquiring and Processing Seismic Survey Data Using Ocean Bottom Cables and Streamers”, U.S. Pat. No. 6,704,244 B1.
Won, I. (1982) “Torsional Shear Wave Generator”, U.S. Pat. No. 4,310,066.

1. A method for acquiring mode-separated seismic data, comprising recording seismic energy transmitted through a medium to one or more sensors in a plurality of seismic energy modes, wherein all sensors preferentially record a selected one of said plurality of seismic energy modes and do not detect translational motion.

2. The method of claim 1, wherein the one or more sensors include at least one of a rotational sensor and a pressure gradient sensor.

3. The method of claim 2, further comprising using one or more hydrophones co-located with said one or more rotational sensors or pressure gradient sensors.

4. The method of claim 1, further comprising using to generate the seismic energy a seismic source that preferentially transmits said selected seismic energy mode.

5. The method of claim 1, wherein the one or more sensors comprise multi-component pressure gradient sensors, located down a borehole, measuring at least two orthogonal horizontal pressure gradient components.

6. The method of claim 5, wherein the multi-component pressure gradient sensors are located along the centerline of the borehole, thereby recording body waves but not tube waves which will have zero gradient at the centerline.

7. The method of claim 1, wherein said one or more sensors comprise a hydrophone co-located with a pressure gradient sensor, wherein the hydrophone and pressure gradient sensor preferentially record compressional waves, with the pressure gradient sensor oriented to measure the vertical component of pressure gradient, and the hydrophone and pressure gradient recordings are used in combination to distinguish between upgoing and downgoing wavefields.

8. The method of claim 7, wherein the method is used in one of an ocean-bottom cable survey, an ocean streamer survey, a borehole survey or a vertical seismic profile.

9. The method of claim 7, wherein the pressure gradient sensors are multi-component sensors, measuring three mutually orthogonal components of the pressure gradient, thereby differentiating lateral as well as vertical seismic wavefield direction.

10. The method of claim 1, wherein the one or more sensors are of two types, each type preferentially recording a different selected one of the plurality of seismic energy modes, and wherein at least one sensor of each type are co-located.

11. The method of claim 10, wherein said two different sensor types are a rotational sensor and a pressure gradient sensor, thereby isolating shear wave mode energy in the rotational sensor's measurements and isolating compressional mode energy in the pressure gradient sensor's measurements.

12. The method of claim 11, wherein the rotational sensor is a multi-component sensor measuring rotational motion about three mutually orthogonal axes.

13. The method of claim 4, wherein the seismic source that preferentially transmits said selected seismic energy mode is a source that imparts angular momentum but not compression.

14. The method of claim 13, wherein the one or more sensors that preferentially record a selected seismic energy mode and do not detect translational motion comprise a rotational sensor, thereby recording only S-S body waves.

15. The method of claim 13, wherein the one or more sensors that preferentially record a selected seismic energy mode and do not detect translational motion comprise a pressure sensor or a pressure gradient sensor, thereby recording only S-P body waves.

16. The method of claim 4, wherein the seismic source that preferentially transmits said selected seismic energy mode is a source that imparts compression but not angular momentum.

17. The method of claim 16, wherein the one or more sensors that preferentially record a selected seismic energy mode and do not detect translational motion comprise a rotational sensor, thereby recording only P-S body waves.

18. The method of claim 16, wherein the one or more sensors that preferentially record a selected seismic energy mode and do not detect translational motion comprise a pressure sensor or a pressure gradient sensor, thereby recording only P-P body waves.

19. An acquisition-based method for mode separation of seismic data, comprising:
recording a first data set of seismic energy transmitted from a first seismic source through a medium in a plurality of modes comprising a first mode and a second mode;
recording a second data set of seismic energy transmitted from a second seismic source through the medium either in a single mode being the first mode, or in a plurality of modes comprising the first mode and the second mode but with a different energy distribution between the modes than for the first seismic source; and
separating the first and second modes by a combination of the two data sets.

20. A system of equipment for acquiring mode-separated seismic data, comprising:
a seismic source;
one or more sensors that preferentially record a selected seismic energy mode and do not detect translational motion.
